(19) United States
(12) Patent Application Publication
(10) Pub. No.: US 2004/0136485 A1
(43) Pub. Date: Jul. 15, 2004

(54) Method and apparatus for quantum mechanical analysis of molecular systems

(76) Inventors: Forrest H. Bennett III, Palo Alto, CA (US); Jessen Yu, San Francisco, CA (US); William Mydlowec, San Francisco, CA (US)

Correspondence Address: Moser, Patterson & Sheridan LLP, Suite 100, 595 Shrewsbury Avenue, Shrewsbury, NJ, 07702, US

(21) Appl. No.: 10/449,948

(22) Filed: May 30, 2003

Related U.S. Application Data
(60) Provisional application No. 60/435,117, filed on Dec. 19, 2002.

(51) Int. Cl. G21B 1/00; G21J 1/00

(52) U.S. Cl. 376/114

(57) ABSTRACT

Methods and apparatus for analyzing molecular systems with reconfigurable special-purpose hardware or an ASIC is provided. The present invention provides methods and apparatus to perform a quantum mechanical calculation on a programmable logic device (PLD) integrated circuit (IC) (“single-chip”) or an application specific integrated circuit (ASIC).

This utility application claims priority to provisional application Ser. No. 60/435,117, filed Dec. 19, 2002.

### FIELD OF THE INVENTION

The invention relates generally to molecular analysis, and more particularly to quantum mechanical analysis of molecular systems.

### BACKGROUND OF THE INVENTION

Quantum mechanics and statistical physics allow one to give exact mathematical descriptions of molecular systems. However, to realize such a mathematical description, it is necessary to have high-power computers and exact computing methods. In the last few years, significant progress has been made. The rapid development of computer hardware and software is well known and quantum mechanical calculations are now one of the most important tools of chemical research.

The theory of quantum mechanics originated in the 1920s. Initially the aim of quantum mechanics was the calculation of all chemical interactions. The well-known Schrodinger equation for stationary states forms the basis for modern quantum chemistry. The Schrodinger equation is HΨ=EΨ; however, the Schrodinger equation—relating waveforms to energy—cannot be solved analytically without approximations. The first such approximations were performed by Hartree in the 1930s using a hand calculator and applying the Self Consistent Field (SCF) method. The most common equations approximating the Schrodinger equation are the matrix equations defined by Hartree-Fock-Roothaan.

Computation of all integrals or “ab initio” quantum mechanics gives the most accurate results. The obtained accuracy, however, depends on the number of gaussian functions that replace the Slater-type function that depicts the actual shape of the molecular orbital. The extraordinary amounts of computer time needed to implement ab initio methods initiated the development of semi-empirical quantum mechanical methods, where only the outer or valence electrons are taken into account. Where ab initio methods use no experimental parameters, semi-empirical methods use parameters derived from experimental data to simplify the computation. The major difference between most semi-empirical methods is the amount of neglect of the diatomic differential overlap integrals.

A third approach to quantum mechanical computations is the density function theory (DFT) approach. Density functional theory is a quantum method that is, in principle, “exact.” Density functional theory calculations are able to be performed more quickly than ab initio methods, but lack the accuracy of ab initio methods and do not allow for systematic improvement.

Thus, semi-empirical or density function theory and ab initio methods differ in the trade-off between computational cost and accuracy. Semi-empirical calculations are relatively inexpensive but only describe ground states and are geared toward computing heats of formation. Ab initio computations provide high quality quantitative predictions for a broad range of systems and are not limited to any specific class of system; however, such computations require a great deal of computer power. Density functional theory approaches fall somewhere in between.

Quantum mechanical algorithms may be used to calculate such physical properties as free energy changes, transition states, electric multipole movements, electron density, molecular orbitals, atomic partial charge, electrostatic potential, structural properties, solvation energy, intra-atomic forces, binding energies of host/guest complexes, and the like. Of these algorithms, different algorithms have different rate limiting steps, but all are extremely time consuming to execute. For example, electronic structure methods typically are rate limited by a matrix diagonalization step which is O(N\hat{ }3) (order n³), and the CISDTQ method is O(N\hat{ }10) (order n¹⁰).

To accelerate quantum calculations using special hardware others have tried:

single program multiple data (SPMD) parallel processor arrays oriented to floating point intensive computations that were essentially general purpose programmable computers, but which had been optimized for various scientific computing tasks including computational chemistry and quantum chromodynamics (QCD) (F. Aglietti, et al., “The teraflop supercomputer APEmille: architecture review and project status report”, preprint submitted to Elsevier Preprint, (Jul. 29, 1997));

a parallel supercomputer where each node consisted of a digital signal processor (DSP) programmed specifically for QCD computations combined with memory and a custom-made communications and memory controller chip (D. Chen, et al., “QCDSP: A Teraflop Scale Massively Parallel Supercomputer”, Technical paper at Super Computer 1997);

an FPGA programmed to implement QCD calculations (A. Nisbet, “Hardware Acceleration of Applications Using FPGAs”, ERCIM Second Workshop on Matrix Computations and Statistics, Rennes, France, Feb. 14-15, 2002. See www.irisa.fr/aladin/wg-statlinNVORKSHOPS/RENNE.); and

a parallel processing random access memory (PPRAM) architecture where the individual processing elements consisted of merged DRAM/LSI logic technology with one 32-bit RISC integer processor, one 76-bit floating-point multiply/accumulate unit, memory, and a communication interface; used to accelerate determination of the coefficients for linear combination of the basis functions in the molecular orbital, which is the rate-limiting process in certain approaches to ab initio molecular orbital calculations (see, U.S. Pat. No. 6,026,422 to Yamada, et al., “Large-scale multiplication with addition operation method and system”).

Three of the foregoing examples of QCD prior art methods address quantum field theory as opposed to quantum mechanics. The PPRAM approach is a quantum mechanical approach, but is not an example of a single circuit dedicated to performing only quantum mechanical calculations. Accordingly, it would be both desirable and useful to provide a quantum mechanical calculation implemented on a single programmable logic device.

### SUMMARY OF THE INVENTION

The present invention provides methods and apparatus for analyzing molecular systems that are faster than those currently of use in the art. In such methods and apparatus, all terms in a quantum mechanical calculation can be implemented in a single chip.

Thus, one embodiment the present invention provides an accelerator for performing quantum mechanical calculations from a molecular system comprising a memory means for storing molecular system atomic data according to atom type and the three dimensional coordinates for each atom in the molecular system; and processing means coupled to the memory means where the processing means is a single integrated circuit dedicated to calculate the quantum mechanical energy of the system. Such quantum mechanical calculations can be made according to ab initio, density functional theory or semi-empirical methods, or any other methods known or developed in the art. Preferred methods of calculation are the direct self consistent field (SCF) approximation, the unrestricted Hartree-Fock (UHF) or restricted Hartree-Fock (RHF) equations, and the semi-empirical CNDO, INDO, NDDO, AM1, and PM3 algorithms. In certain embodiments of the invention, the accelerator is a field programmable gate array (FPGA) or an application specific integrated circuit (ASIC).

In yet another aspect of the invention, the present invention provides a method for a quantum mechanical calculation for a molecular system on a single programmable logic device, comprising configuring the single programmable logic device for a first portion of the calculation; performing the first portion of the calculation on the single programmable logic device; and reconfiguring the single programmable logic device for a second portion of the calculation.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the present invention may admit to other equally effective embodiments.

FIG. 1 is a block diagram of an exemplary embodiment of an FPGA accelerator coupled to a host computer in accordance with one or more aspects of the present invention.

FIG. 2 is a block diagram of an exemplary embodiment of an ASIC accelerator coupled to a host computer in accordance with one or more aspects of the present invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

The present invention provides methods and apparatus for implementing all terms of a quantum mechanical calculation with a single chip or circuit. As discussed previously, the three quantum chromodynamics QCD implementations listed in the Background above are different from the current invention in that QCD is a quantum field theory that accounts for strong nuclear force, while the methods accelerated in the present invention are quantum mechanical, not quantum field theories. The PPRAM approach mentioned above is not an example of a digital circuit that is fully dedicated to only performing quantum mechanical calculations—i.e., the computer used was a general purpose computer and could still be reprogrammed to perform non-quantum mechanical computations. Thus, before the present invention, neither a programmable logic device (PLD) nor an application specific integrated circuit (ASIC) had been used to implement a digital circuit dedicated to performing solely quantum mechanical calculations—i.e., once programmed, the digital circuit is not itself programmable. The rate limiting step in most quantum mechanical calculations is O(N\hat{ }3) (order n³) or higher. Thus, it is desirable and useful to provide a dedicated molecular mechanics calculation implemented on a single PLD or ASIC.

As stated, the various algorithms or methods that can be used in accordance with the present invention have differing rate limiting steps. For example, the PM3 algorithm has a rate limiting step of O(N\hat{ }3) (n³). However, the time complexity of the PM3 algorithm could be linearized in various ways, reducing the time limiting step from n³ to n. The methods and apparatus of the present invention could still be applied to the linearized PM3 algorithm; that is, the present invention can be applied to quantum mechanical computations as they are known in the art, or as they might be modified for specific applications.

The present invention allows for all terms of a quantum mechanical algorithm to be implemented by a single integrated circuit such as a field programmable gate array or an application specific integrated circuit. Examples of quantum mechanical algorithms that can be implemented in such a manner are semi-empirical calculations. Semi-empirical calculations commonly are carried out in valent approximations CNDO, INDO, and NDDO. In these approximations, the calculations are carried out only for valent electrons and the electrons of interior shells are included in the skeleton of the molecule, minimal basis sets are used, and a significant part of the Coulomb integrals is neglected. Neglecting the Coulomb integral is essential in allowing one to simplify the calculation. It is possible to compensate at least partially for the inaccuracy of calculations by choosing carefully the parameters to be used in the calculation. In the CNDO approximation (Complete Neglect of Differential Overlap), the one-center integrals of a type <ii|ii> and two-center integrals of a type <ii|kk> are taken into account. In the INDO approximation (Intermediate Neglect of Differential Overlap), Coulomb integrals at which all four orbitals xᵢ, xⱼ, xₖ, xₗ belong to one atom additionally are taken into account. In the NDDO approximation (Neglect of Diatomic Differential Overlap), in addition to integrals—which are taken into account in approximations CNDO and INDO—integrals <ij|kl> where orbitals xᵢ and xⱼ belong to one atom and xₖ and xₗ to another also are taken into account. The use of various parameters or empirical formulas is a matter of choice; thus, there are various modifications of all these methods in use in the art.

For the last several years, the NNDO-like methods (approximation NNDO) such as MNDO, AM1 and PM3, have been the most widespread among semi-empirical methods. For example, for five years after MNDO development in 1977, not less than 150 publications were devoted to calculations by this method. The popularity of MNDO-like methods is promoted by the distribution of the AMPAC and MOPAC software programs, which are based on these methods. All three methods differ from one another in relatively insignificant ways and yield approximately the same results.

Other examples of quantum mechanical algorithms that can be implemented in the methods and apparatus of the present invention are ab initio algorithms. Ab initio methods use no experimental parameters and are based solely on the laws of quantum mechanics—the first principles referred to in the name ab initio—and on the values of a small number of physical constants. Examples of such ab initio methods are the direct self consistent field (SCF) approximation and the Monte Carlo self consistent field approximation (MCSCF); the unrestricted Hartree-Fock (UHF) or restricted Hartree-Fock (RHF) equations; and ab initio methods that take correlation energy into account such as configuration interaction (CI) methods (CIS (single), CID (double), CISD (single double), CISDT (single double triple)); coupled cluster (CC) methods (CCD (double), CCSD (single double), CCSDT (single double triple)); QCISD and QCISDT methods; perturbation theories such as the Moeller-Plesset perturbation theory (MPn); the valence bond methods (spin coupled valence bond (SCVB) and generalized valence bond (GVB) methods); and the Huckel and Extended Huckel electronic structure methods.

The methods and apparatus of the present invention also may employ DFT methods. DFT approaches are self consistent solutions for φ_{iσ} that resemble those of Hartree-Fock theory, but DFT orbitals have no physical significance other than constituting charge density. DFT wavefunction is not a Slater determinant of spin orbitals; in fact, in a strict sense there is no N-electron wave function available in DFT. Various DFT approaches include local density approximation (LDA), local spin density approximation (LSDA), G2 (gradient control), SVWN, BLYP, BPW91, B3LYP, and B3PW91.

References helpful in understanding the various quantum mechanical algorithms include: Alan Hinchliffe, Computational Quantum Chemistry, John Wiley & Sons (1988); David Young, Computational Chemistry, Wiley Interscience (2001); Andrew R. Leach, Molecular Modeling: Principles and Applications, Addison Wesley Longman Limited (1996); and Frank Jensen, Introduction to Computational Chemistry, John Wiley & Sons (1999). Though a number of different algorithms have been listed herein, the present invention should not be listed to these algorithms, but it should be understood to one skilled in the art that the methods and apparatus of the present invention could be utilized with any algorithm used to make quantum mechanical calculations.

An example of one general method for a quantum mechanical algorithm on a reconfigurable FPGA is below:

Input numerical data for molecular system. Numerical input data includes for each atom in the molecular system, the x, y, and z coordinates of the atom, and the element type of the atom.

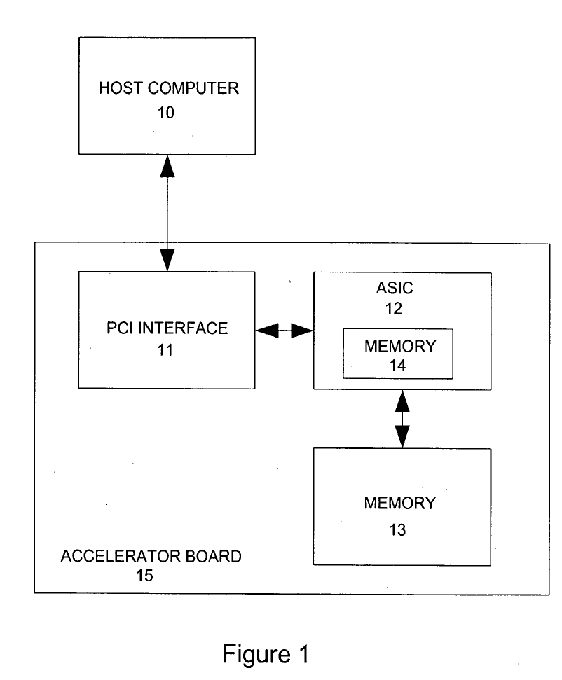

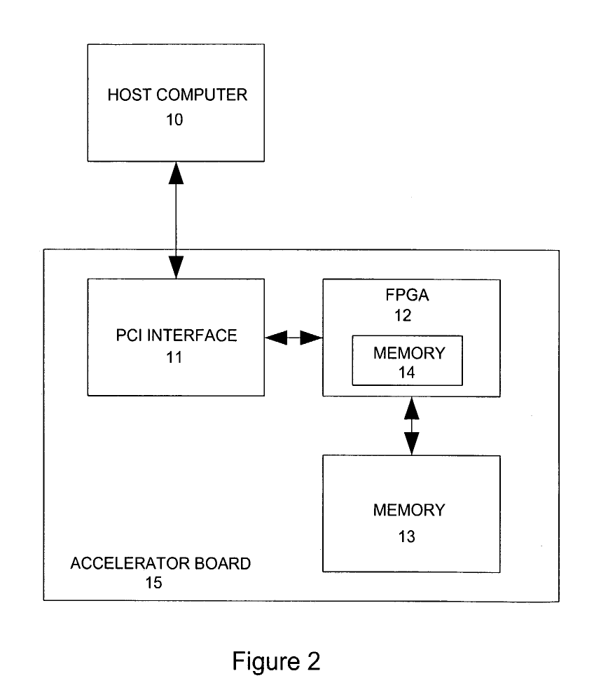

Referring to FIGS. 1 and 2, host 10 via PCI interface 11 transmits the numerical data for the molecular system to accelerator board 15. All this data may be stored in memory 13 on accelerator board 15.

Host 10 initializes the total energy for the molecular system to zero.

Host 10 performs the following three steps one or more times:

Host 10 reconfigures FPGA 12 (FIG. 1) or ASIC (FIG. 2) for the next part of the quantum mechanical calculation.

Host 10 starts the quantum mechanical calculation on FPGA 12.

When this part of the calculation is done, host 10 reads the energy result from FPGA 12 via memory 14 and memory 13.

Host repeats each of the last 3 steps for each part of the quantum mechanical calculation.

### EXAMPLE

Below is one example of an embodiment of the present invention implementing an electronic structure semi-empirical quantum mechanical algorithm such as CNDO, INDO, NDDO, MINDO/3, AM1, PM3, SAM1, SAM1D, or MDDO/d on a reconfigurable FPGA. In this embodiment, the rate limiting step is the diagonalization of the Fock matrix. Therefore, this embodiment implements the diagonalization process on an FPGA, and the rest of the algorithm is performed in software in the standard way.

The MOPAC 93 software package is a standard implementation of MINDO/3, MNDO, AM1, and PM3. The steps described below are as implemented by MOPAC 93, except that the diagonalization of the Fock matrix is implemented in an FPGA.

Input numerical data for molecular system. Numerical input data includes for each atom in the molecular system, the x, y, and z coordinates of the atom, and the element type of the atom;

Convert the x, y, and z coordinates for the molecular system to an interatomic distance matrix;

One electron matrix is created from the interatomic distance matrix. This one electron matrix shows on the diagonals the energy of each electron as if it were associated with only a single atom, and off diagonals are the energies of each electron as if it were associated with only two atoms;

Create the two electron integral matrix, which gives the repulsive interactions between pairs of electrons;

Create the initial density matrix by assuming that each electron is localized to one atom. The diagonals of this matrix are set to the core charge of the atom divided by the number of atomic orbitals, and the off diagonals are all set to zero;

Use the initial density matrix to create the initial Fock matrix which is the sum of the one electron interactions and the two electron interactions;

Host 10 via PCI interface 11 transmits the initial Fock matrix data for the molecular system to accelerator board 15. All this data may be stored in memory 13 on accelerator board 15;

The FPGA 12 diagonalizes the Fock matrix to give the eigenvalues and eigenvectors (the diagonalization method used can be any standard technique such as Jacobi, Householder-QR/QL, etc.) which is then stored in memory 14 and transferred to memory 13;

Host 10 reads the diagonalized Fock matrix, eigenvalues, and eigenvectors from memory 13;

The new density matrix is computed from the diagonalized Fock matrix;

The new Fock matrix is computed from the new density matrix;

A self-consistency check is performed to see if the iterative process has converged. If it has converged, then the iterative process is complete. If it has not converged, then the steps of diagonalizing the Fock matrix, creating a new density matrix, and creating a new Fock matrix are repeated until the process converges. For Example, one way to determine that the iterative process has converged, or reached self-consistency, is to compute whether the total electron energy of the Fock matrix has changed on successive iterations by less than some predefined threshold.

Run-time reconfiguration of a field programmable gate array as described in the following reference is incorporated by reference herein in its entirety: E. Lemoine and D. Merceron, “Run Time Reconguration of FPGA for Scanning Genomic Data Bases”, IEEE Symposium on FPGAs for Custom Computing Machines, pp. 90-98 (1995). Also see U.S. Pat. No. 5,717,621 Speedup for solution of systems of linear equations.

While the present invention has been described with reference to specific embodiments, it should be understood by those skilled in the art that various changes may be made and equivalents may be substituted without departing from the true spirit and scope of the invention. In addition, many modifications may be made to adapt a particular situation, material, or process to the objective, spirit and scope of the present invention. All such modifications are intended to be within the scope of the invention.

All references cited herein are to aid in the understanding of the invention, and are incorporated in their entireties for all purposes.

1. An accelerator for performing quantum mechanical energy calculations for a molecular system, comprising:
memory means for storing atomic data for the molecular system including atom type and three-dimensional coordinates for each atom in the molecular system;
processing means coupled to the memory means, the processing means being a single integrated circuit having programmable logic programmed to calculate the quantum mechanical energy of the molecular system.

2. The accelerator according to claim 1, wherein the processing means is a field programmable gate array (FPGA).

3. The accelerator according to claim 2, wherein the processing means is an application specific integrated circuit (ASIC).

4. The accelerator of claim 1, wherein the quantum mechanical energy calculations implement ab initio methods.

5. The accelerator of claim 4, wherein the ab initio methods are algorithms selected from SCF, MCSCF, UHF, RHF, CIS, CID, CISD, CISDT, CCD, CCSD, CCSDT, QCISD, QCISDT, MPn, SCVB, GVB, Huckel or Extended Huckel electronic structure methods

6. The accelerator of claim 1, wherein the quantum mechanical energy calculations implement semi-empirical methods.

7. The accelerator of claim 6, wherein the semi-empirical methods are algorithms selected from CNDO, INDO, NNDO, MNDO, AM1 or PM3.

8. The accelerator of claim 1, wherein the quantum mechanical energy calculations implement density functional theory methods.

9. The accelerator of claim 8, wherein the density functional theory methods are algorithms selected from LDA, LSDA, G2, SVWN, BLYP, BPW91, B3LYP, or B3PW91.

10. The accelerator of claim 1, wherein the rate limiting step of the quantum mechanical energy calculation is O(N\hat{ }3) or higher.

11. A method for quantum mechanical energy calculation for a molecular system on a single programmable logic device, the method comprising:
configuring the single programmable logic device for a first portion of the calculation;
performing the first portion of the calculation on the single programmable logic device; and
reconfiguring the single programmable logic device for a second portion of the calculation.

12. The method according to claim 11, wherein the single programmable logic device is a field programmable gate array, and wherein the field programmable gate array is coupled to a signal bearing medium having instructions for configuring and reconfiguring the field programmable gate array.

13. The method according to claim 12, further comprising:
performing the second portion of the calculation on the field programmable gate array; and
reconfiguring the field programmable gate array for a third portion of the calculation.

14. The method according to claim 13, further comprising repeating the configuring, performing, reconfiguring, and second performing steps for each remaining portion of the calculation.

15. An apparatus comprising a single chip configured to calculate a quantum mechanical molecular system interaction.

16. The apparatus according to claim 15, wherein the single chip is a field programmable gate array or an application specific integrated circuit.

17. The apparatus of claim 15, wherein the quantum mechanical molecular system interaction is determined by an ab initio, semi-empirical or density functional theory method.

18. The apparatus of claim 17, wherein the ab initio, semi-empirical or density functional theory method methods are algorithms selected from SCF, MCSCF, UHF, RHF, CIS, CID, CISD, CISDT, CCD, CCSD, CCSDT, QCISD, QCISDT, MPn, SCVB, GVB, Huckel, Extended Huckel electronic structure methods, CNDO, INDO, NNDO, MNDO, AM1, PM3, LDA, LSDA, G2, SVWN, BLYP, BPW91, B3LYP, or B3PW91.

19. An apparatus comprising a single chip configured to calculate a molecular system interaction by reconfiguring the single chip for different parts of the quantum mechanical calculation.

20. The apparatus of claim 19, wherein the rate limiting step of the molecular system interaction calculation is O(N\hat{ }3) or higher.
